(19) United States
(12) Patent Application Publication
(10) Pub. No.: US 2025/0162853 A1
(43) Pub. Date: May 22, 2025

(54) COOLING ARRANGEMENT FOR A BEVERAGE DISPENSING SYSTEM

(71) Applicant: Carlsberg Breweries A/S, Copenhagen V (DK)

(72) Inventor: Klaus Laybourn, Copenhagen V (DK)

(73) Assignee: Carlsberg Breweries A/S, Copenhagen V (DK)

(21) Appl. No.: 18/839,512

(22) PCT Filed: Feb. 24, 2023
(86) PCT No.: PCT/EP2023/054642

§ 371 Date: Aug. 19, 2024

(30) Foreign Application Priority Data
Feb. 25, 2022 (EP) 22158861.9

(51) Int. Cl. B67D 1/08

(52) U.S. Cl. CPC B67D 1/0859

(57) ABSTRACT

A cooling arrangement for a beverage dispensing system includes a housing and a pressure source for applying pressure on a beverage container to dispense a beverage; wherein inlet apertures and outlet apertures are arranged in the side wall of the housing for allowing airflow into the housing; and an air channel extends between the inlet aperture and the outlet aperture. Heat exchange means are arranged for receiving heat from the beverage container; and a condenser is arranged in the air channel in thermal connection with the heat exchange means for emitting heat received from the beverage container to the air channel and provide efficient cooling. The housing may be defined horizontally by a rounded hourglass shape for a compact and fail-safe form factor.

### TECHNICAL FIELD

The disclosure relates to a beverage dispensing system for dispensing a beverage stored in a beverage container, and more particularly to a cooling arrangement arranged in the beverage dispensing system for cooling the beverage container.

### BACKGROUND

Conventional beverage dispensing systems intended for professional or private use such as the DraughtMaster system produced by the applicant company are described in e.g., Wo 2007/019848, WO 2007/019849, WO 2007/019850, WO 2007/019851 and WO 2007/019853.

Beverage dispensing systems are typically used in beverage dispensing establishments for efficiently dispensing large quantities of beverage, including carbonated alcoholic beverages such as draught beer and cider, non-alcoholic beverages such as soft drinks and non-carbonated beverages such as wine and fruit juice. The dispensing of beverages is typically achieved by providing the beverage in a pressurized beverage container referred to as a keg and allowing the beverage to flow via a beverage line to a beverage tap. Traditionally, steel containers connected to a carbon dioxide supply or a mixed gas supply have been used; however, nowadays collapsible polymeric containers also exist, one example being disclosed in the applicant's own international application WO2009/02414.

These beverage dispensing systems had traditionally been used by professional users in establishments like bars, restaurants and hotels. However, there is an increasing need by private persons to also use beverage dispensing systems at home, such as beer drafting units with replaceable beer kegs from which the beer is expected to be dispensed at the right temperature that is generally much lower than the temperature of the environment.

Since most beverages include nutrients and other substances which may promote bacterial growth it is important to cool these kegs during use in the dispensing systems. Insufficient cooling and too high temperatures lead to bacterial growth causing health problems for the beverage consumer, in addition to the unsatisfactory user experience of consuming beverage at an uncomfortably high temperature.

One example from the prior art addressing this problem is U.S. Pat. No. 3,889,487 showing a system in which a beverage keg is connected by a flexible conduit to a faucet on a faucet standard, wherein the keg is kept in a refrigerated chamber and the beverage is pressurized by supplying carbon dioxide into the keg. One problem with such traditional cooling solutions is that keeping the refrigerated chamber at constant low temperatures requires either a continuous supply of cooling medium, or a high efficiency cooling system that usually employs one or more high performance fans. These solutions are problematic less for professional establishments due to the availability of space and industrial supplies, and the already high levels of noise. However, these systems are not feasible for smaller sized beverage dispensing systems intended for private use as they generate very loud noise and/or need professional maintenance.

Self-chilling vessels offer another alternative for private users, based mainly on two different principles, where the first principle uses a closed system separated from the product to be cooled and upon activation initiates an endothermic reaction, which cools the product. U.S. Pat. Nos. 6,266,879 and 6,178,753 describe containers based on this principle. The second principle is based on a closed two-chamber system separated from the product to be cooled, where one chamber comprises an evaporation unit and the second chamber comprises an absorbing unit. When a valve is opened between the two chambers a drop-in pressure causes fluid to evaporate from the evaporation chamber and thereby removing heat from the evaporator. A heat removing material in the second chamber absorbs heat of vaporisation. U.S. Pat. No. 6,829,902 describes a self-cooling can based on the phase-change principle. A drawback related to self-chilling vessels designed according to the prior art is the need of specially designed containers which containers comprise the cooling elements inside. The need of specially made containers with certain pressurized cavities with specific materials inside makes the manufacturing process very expensive.

EP3246385A1 shows a beer maker and dispensing system intended for professional but also private users, including a more traditional refrigeration cycle apparatus with a compressor, a condenser, an expansion device, and an evaporator disposed at a fermentation tank. The refrigeration cycle apparatus controls the temperature of the fermentation tank by circulating a refrigerant; and a heat insulating wall surrounds the fermentation tank and the evaporator. The system may also include an air pump for providing an air flow to the inside of the fermentation tank, however no air circulation is intended between the inside of the device and the surrounding environment. This system can maintain a temperature suitable for a fermentation tank using a relatively simple structure, however it is not intended to provide a cooling effect sufficient for chilling a beverage to a temperature intended for consumption or keeping fresh, i.e. avoiding substantial biological activity in the beverage.

WO2018212660A1 describes a beverage dispensing assembly suitable for private use comprising a dispenser and a beverage container, wherein the dispenser comprises a housing provided with a receptacle for receiving at least part of the container positioned with the neck and shoulder portion facing downward. The housing comprises a cooling device for cooling the wall of the receptacle and, through contact cooling, a part of the beverage container. The cooling can be provided by a compressor-based cooling device, a piezo based cooling device, ice cube cooling, liquid cooling or the like.

This assembly can provide a good solution for cooling the beverage efficiently to a desired temperature for a user as it cools an area from which the beverage will generally be dispensed. However, the system only provides a limited efficiency in keeping the whole beverage container at lower temperatures.

EP1289874B1 describes a beverage dispensing system with an air-cooled refrigerator wherein air is taken in and passed by cooling means using a fan and is forced to flow around beverage containers disposed in the housing for cooling. The refrigerator is arranged under a tapping platform such that air can be sucked in along the upper side and the back of the refrigerator and can be discharged along an evaporator arranged under the refrigerator. This solution carries disadvantages inherent in traditional refrigerators as well, namely that the intake or the outflow channels, or even both, tend to get blocked over time by accumulated dirt, dust, and other contaminants. A further issue with such solutions is inherent in their rectangular shape, which allows these refrigerators to be placed close to walls, or even in corners, where air circulation is limited from the start of their operation and is only further limited by any blockage over time. Although EP1289874B1 addresses this issue by providing a bottom designed to be opened for cleaning, this still requires frequent manual maintenance, which is often neglected in both private or professional context, and can lead to lowered performance or malfunction, affecting the quality or even safety of the beverage for consumption.

Consequently, there is still a need for an efficient cooling solution for beverage dispensing systems that are suitable for private use, require low or no maintenance for long periods, and can keep beverage containers at desired low temperatures in order to keep the beverage therein fresh, both to prevent microbiological growth and to enable desired consumption temperatures.

### SUMMARY

It is therefore an object of the present disclosure to provide an improved beverage dispensing system that solves at least one of the problems present in the prior art. The foregoing and other objects are achieved by the features of the independent claims. Further implementation forms are apparent from the dependent claims, the description and the figures.

According to a first aspect, there is provided a beverage dispensing system comprising a housing with a bottom, a top, and a continuous side wall together defining an enclosure for receiving at least a portion of a collapsible beverage container. A pressure source is provided for applying pressure on the collapsible beverage container to at least partially collapse said beverage container and thereby push out and dispense a beverage from the inside of the container. The housing further comprises an inlet aperture arranged in the side wall for allowing airflow from a space outside the housing into the enclosure; and an outlet aperture arranged in the side wall downstream from the inlet aperture for allowing airflow from the enclosure to a space outside the housing, with an air channel extending between the inlet aperture and the outlet aperture. The system is provided with a cooling arrangement comprising heat exchange means arranged in the housing for receiving heat from the beverage container when the beverage container is received housing; and a condenser arranged in the air channel and in thermal connection with the heat exchange means, for emitting heat received from the beverage container to the air channel.

The disclosed beverage dispensing system allows for a compact design which, through the combination of the air channel and the cooling arrangement can efficiently provide sufficiently low temperatures for any beverage container inserted therein to keep the beverage fresh for long term. The system also requires low maintenance due to the inlet and outlet apertures both arranged in the side walls, thereby reducing the accumulation of dust and other contaminants that would block the flow of air through the housing.

In a possible implementation form of the first aspect the heat exchange means comprise a heat sink wall arranged in thermal connection with the beverage container when the beverage container is received in the housing, and an evaporator arranged in thermal connection with the heat sink wall. The cooling device further comprises a compressor; and the evaporator, the compressor, and the condenser is interconnected through a cooling duct for circulating a cooling substance. The duct further comprises an expansion valve being arranged in the duct between the condenser and the evaporator to provide a vapor-compression cycle for cooling the beverage container.

In a further possible implementation form of the first aspect the beverage container comprises a closure with a beverage outlet, and the housing comprises a cavity designed to accommodate the closure and at least a portion of the beverage container when the beverage container is received in the housing. The cavity is delimited at least partially by the heat sink wall with the evaporator arranged at least partially surrounding the heat sink wall for cooling the beverage container.

In a further possible implementation form of the first aspect the housing comprises a first housing portion for receiving the beverage container; a second housing portion arranged laterally to the first housing portion and connected to the first housing portion through the side wall. The outlet aperture is arranged in the side wall of the first housing portion; and the inlet aperture is arranged in the side wall of the second housing portion, thereby allowing a channeled airflow between an outer side of the first housing portion and an outer side of the second housing portion through the air channel.

In a further possible implementation form of the first aspect both the heat exchange means and the condenser is arranged in the first housing portion; and a compressor is arranged in the second housing portion.

In a further possible implementation form of the first aspect the side wall comprises an inlet segment comprising a set of inlet apertures including the inlet aperture; an outlet segment comprising a set of outlet apertures including the outlet aperture; and at least one continuous segment uninterrupted by apertures arranged between the inlet segment and the outlet segment.

In a further possible implementation form of the first aspect the condenser is arranged in the air channel in front of the outlet segment for enabling efficient heat emission through the side wall.

In an embodiment the condenser is arranged in parallel to the outlet segment, with a clearance arranged between the condenser and the outlet segment.

In an embodiment the side wall comprises an inner side towards the enclosure and an outer side towards a space outside the housing, wherein the air channel extends along the inner side of the side wall.

In a further possible implementation form of the first aspect at least one ventilator is arranged in the air channel for providing forced air flow in the air channel for a more efficient cooling effect.

In a further possible implementation form of the first aspect at least two ventilators are arranged in the air channel, along opposite sides of the housing, for an even more efficient cooling effect.

In a further possible implementation form of the first aspect the ventilators are arranged in parallel to provide a unilateral air flow, wherein air flows through all the ventilators from the inlet aperture to the outlet aperture.

In a further possible implementation form of the first aspect at least one partition wall is arranged in the air channel on an outflow side of the at least one ventilator, each partition wall arranged to fill the cross-section of the air channel, and each partition wall comprising a hole for restricting and channeling air flow from the respective ventilator through the partition wall.

In a further possible implementation form of the first aspect at least one partition wall further comprises flow directing means for directing air flow from the partition wall within the air channel, the flow directing means being arranged on an opposite side of the at least one partition wall to the ventilator.

In a further possible implementation form of the first aspect the housing comprises a receptacle for receiving the beverage container, the receptacle comprising a base portion and an at least partially removable lid portion. The receptacle further comprises an additional heat sink layer, arranged in at least one of the base portion or the lid portion, for providing additional cooling when the beverage container is received in the receptacle.

In a further possible implementation form of the first aspect at least a portion of the additional heat sink layer is arranged in the lid portion, the heat exchange means being arranged in the base portion; and the housing further comprising a thermal bridge arranged between the base portion and the lid portion, providing a thermally conductive connection between the additional heat sink layer and the heat exchange means.

In a further possible implementation form of the first aspect the receptacle defines a sealable pressure chamber when the lid portion is attached to the base portion, and wherein pressurized fluid from the pressure source can be applied to the pressure chamber for pressurizing the beverage container to dispense a beverage.

In a further possible implementation form of the first aspect the beverage container comprises a beverage filled bag inside an outer shell, wherein pressurized fluid from the pressure source can be applied to a space between the outer shell and the bag for pressurizing the beverage container to dispense a beverage.

In a further possible implementation form of the first aspect the beverage dispensing system comprises a beverage dispensing line connected on one end to a beverage outlet of the beverage container and arranged at least partially within the housing when the beverage container is received in the housing. The cooling device in this implementation comprises a compressor and a heat insulation layer arranged between at least a portion of the beverage dispensing line and the compressor.

In a further possible implementation form of the first aspect a heat sink layer is arranged in the housing for providing additional cooling for the beverage container; and at least one portion of the beverage dispensing line is disposed in thermal connection with the heat sink layer when the beverage container is received in the housing for providing additional cooling for a beverage flowing in the beverage dispensing line.

In a further possible implementation form of the first aspect the side wall comprises at least one curved segment; wherein at least one of the inlet aperture or the outlet aperture is arranged in a curved segment; and wherein at least a portion of the condenser is arranged in the air channel along a curved segment, the condenser comprising curved ducts corresponding to the shape a respective curved segment.

This and corresponding curved shapes described in the following implementation forms provide a form factor for the beverage dispensing system that ensure proper clearance between the housing of the system and any wall or obstacle that the housing is placed next to. This in turn ensures proper air circulation both into and out from the housing, thereby ensuring efficient cooling and avoiding clogging of the inlet and outflow apertures.

In an embodiment the curved segment is shaped as a half cylinder, and the condenser is arranged along at least a portion of the curved segment, preferably the entirety of the curved segment, with the condenser in some embodiments even extending over the curved segment on at least on one end.

In an embodiment the side wall only comprises curved segments.

In an embodiment the housing has a cylindrical shape, the cylindrical shape defined by an oval, circular, or elliptical cross section.

In a further possible implementation form of the first aspect the side wall comprises at least two curved segments arranged at opposite sides of the housing, wherein the inlet aperture and the outlet aperture are arranged in different ones of the at least two curved segments; and wherein a compressor is arranged in the housing at a curved segment opposite to the condenser.

In an embodiment the side wall only comprises two curved segments, the two curved segments being connected by straight segments, providing a straight slot shape for the housing.

In a further possible implementation form of the first aspect the housing is defined horizontally by a rounded hourglass shape, the side wall comprising four curved segments, the four curved segments comprising two concave curved segments and two convex curved segments arranged intermittently; and wherein the condenser and the compressor are arranged at respective concave curved segments.

In an embodiment the first housing portion is larger than the second housing portion, and the condenser is arranged in the first housing portion, at a side of the first housing portion facing away from the second housing portion.

In an embodiment the second housing portion is larger than the first housing portion, and the condenser is arranged in the second housing portion, at a side of the second housing portion facing away from the first housing portion.

In an embodiment the cooling substance is a refrigerant comprising at least one of hydrocarbon and hydrofluoroolefin, such as R-32, R-290, R-600a, R-454b, R-1234yf, R-514A, R-744, R-1234ze and R-1233zd, most preferably R-600a.

These and other aspects will be apparent from and the embodiment(s) described below.

### BRIEF DESCRIPTION OF THE DRAWINGS

In the following detailed portion of the present disclosure, the aspects, embodiments and implementations will be explained in more detail with reference to the example embodiments shown in the drawings, in which:

FIG. 1 shows a vertical cross-section along the axis S1 of a beverage dispensing system with a cooling arrangement in accordance with an embodiment;

FIG. 2 shows a schematic horizontal cross-section along the axis S2 of a beverage dispensing system with a cooling arrangement in accordance with an embodiment;

FIG. 3 shows a detailed horizontal cross-section along the axis S2 of a beverage dispensing system with a cooling arrangement in accordance with an embodiment;

FIG. 4 shows an isometric view of a beverage dispensing system cut at a horizontal plane in accordance with an embodiment;

FIGS. 5A and 5B show further isometric views of a beverage dispensing system in accordance with further embodiments;

FIGS. 6A and 6B show schematic horizontal cross-sections of beverage dispensing systems with a cooling arrangement in accordance with further possible embodiments;

FIG. 7 shows a detailed vertical cross-section along the axis S1 of a beverage dispensing system with a cooling arrangement in accordance with an embodiment;

FIG. 8 shows a partial vertical cross-section along the axis S1 of a beverage dispensing system with a cooling arrangement in accordance with an embodiment;

FIG. 9 shows a partial isometric cross-section along the axis S1 of a beverage dispensing system with a cooling arrangement in accordance with an embodiment;

FIG. 10 shows a partial isometric side view of a beverage dispensing system in accordance with an embodiment, with the housing and some further parts removed;

FIG. 11 shows a schematic vertical cross-section of a beverage dispensing system in accordance with an alternative embodiment; and

FIGS. 12A and 12B show schematic horizontal cross-sections of beverage dispensing systems in accordance with further alternative embodiments.

### DETAILED DESCRIPTION

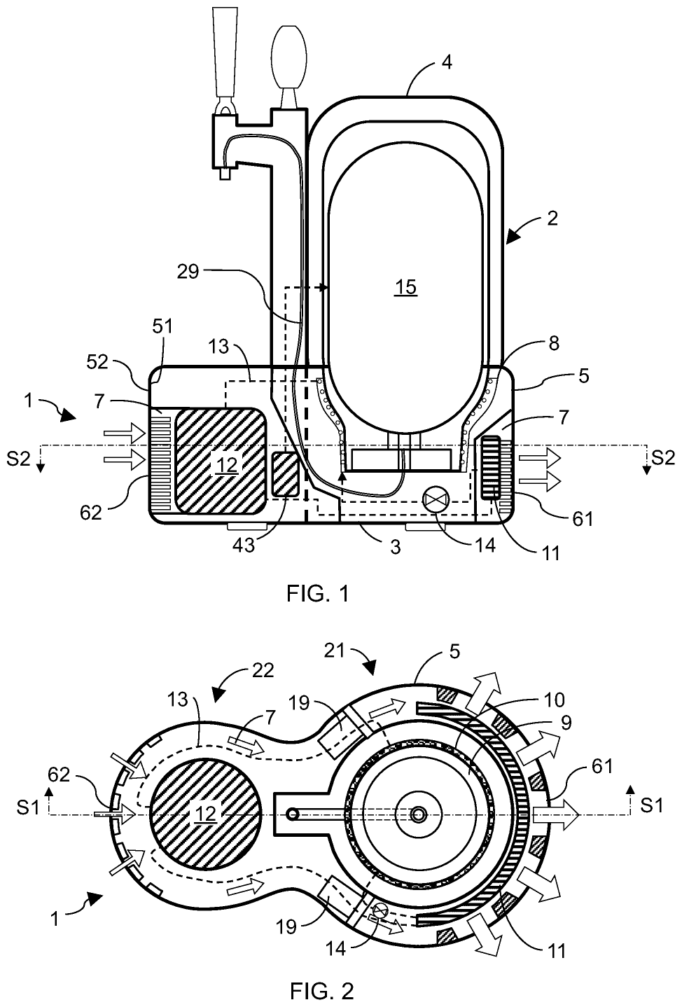

FIG. 1 shows a vertical cross-section along the axis S1 (as shown in FIG. 2) of a beverage dispensing system with a cooling arrangement 1 according to an embodiment of the present disclosure. The beverage dispensing system is configured for dispensing a beverage from a beverage container 15 arranged therein. The beverage may be include but not limited to beer, a carbonated malt-based beverage, non-alcoholic beer, or cider.

The beverage container 15 may be a lightweight, collapsible and disposable beverage container (keg). The collapsible beverage container 15 can be made of thin and flexible plastic material or may even be in the form of a plastic bag.

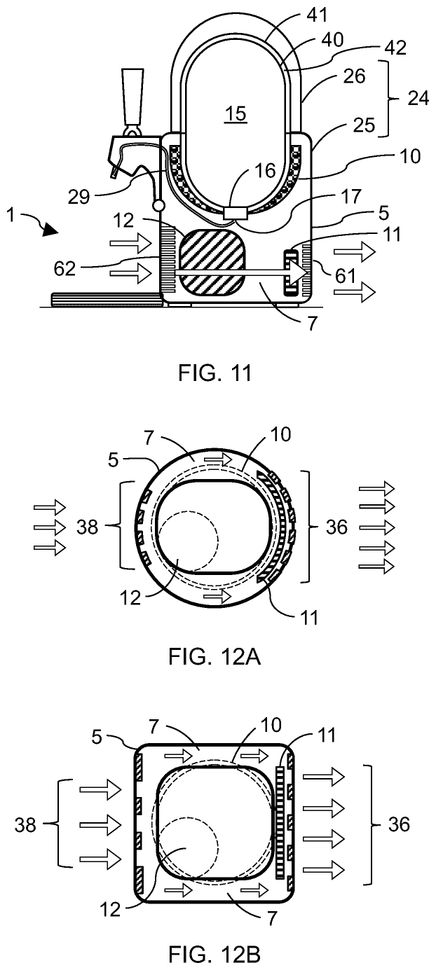

While performing a dispensing operation, pressure is applied that causes the beverage to flow out of the beverage container 15 and through a dispensing line 29 that leads to a tapping head equipped with a tap handle. The tap handle allows the operator to control the tapping valve and thereby the beverage dispensing operation. Typically, the tap handle is a part of a beverage font mounted in a bar, such as shown in e.g. FIG. 1, or when using a smaller beverage dispensing system, the tap handle may be mounted on a housing 2 of the beverage dispensing system, and typically in front of the beverage container 15, as shown in e.g. FIG. 11, so that the tap handle may be easily used by the operator to dispense the beverage.

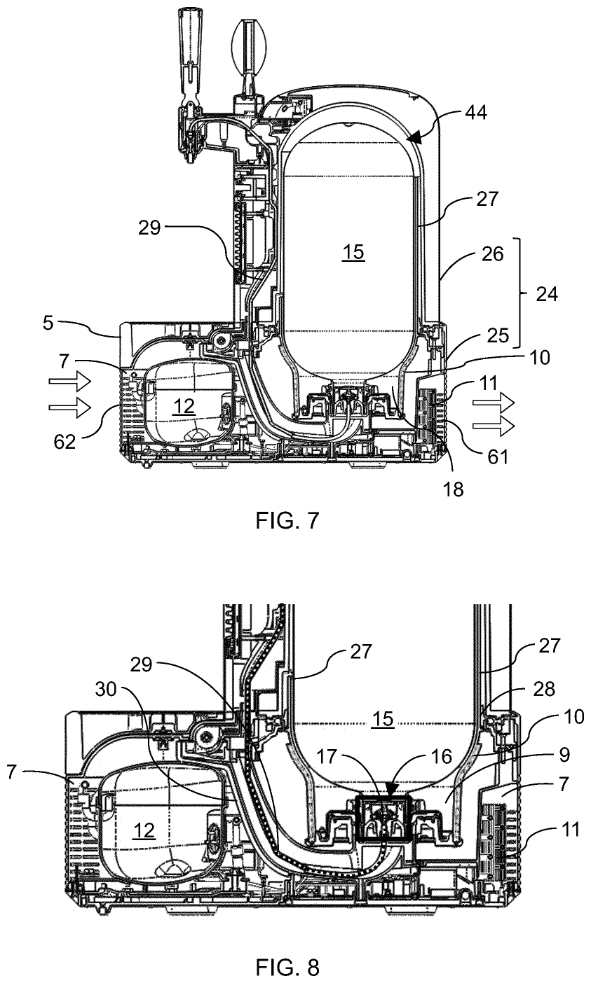

The beverage thus is dispensed from the beverage container 15 through a beverage dispensing line 29 connected on one end to a beverage outlet 17 of the beverage container 15 and arranged at least partially within the housing 2 and optionally also in drawn through beverage font assembly, when the beverage container 15 is received in the housing 2, as shown in more detail in FIGS. 7 and 8.

As shown in FIG. 1, the beverage dispensing system comprises a housing 2 with a bottom 3, a top 4, and a continuous side wall 5 together defining an enclosure for receiving at least a portion of a beverage container 15. The side wall 5 comprises an inner side 51 towards the enclosure and an outer side 52 towards a space outside the housing 2. At least one inlet aperture 62 is arranged in the side wall 5 for allowing airflow from a space outside the housing 2 into the enclosure (illustrated by the arrows on the left); while a further at least one outlet aperture 61 is also arranged in the side wall 5 downstream from the inlet aperture 62 for allowing airflow from the enclosure to a space outside the housing 2 (illustrated by the arrows on the right).

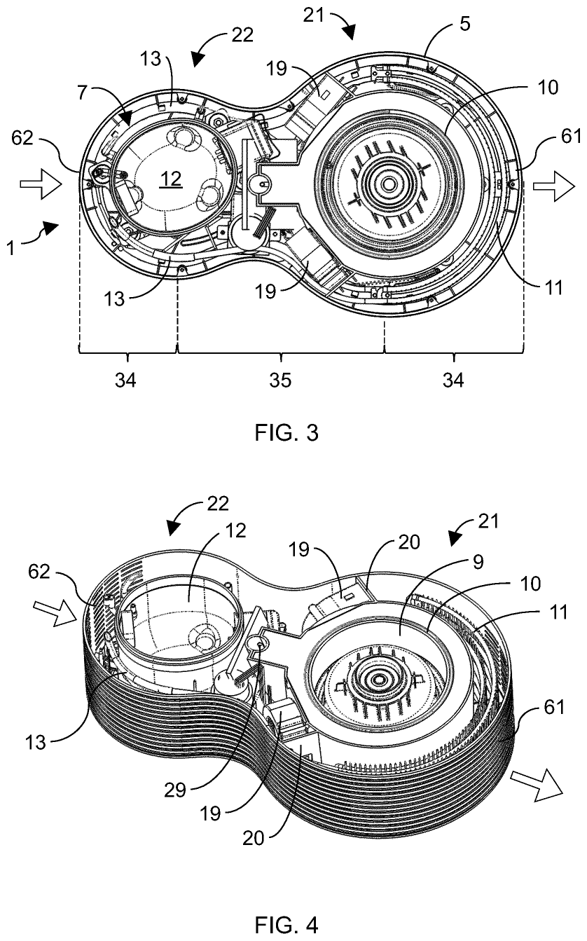

An air channel 7 is arranged in the housing 2 to extend at least between the inlet aperture 62 and the outlet aperture 61 (better shown in the horizontal cross-sections of FIGS. 2 and 3). The air channel 7 extends along the inner side 51 of the side wall 5.

The system further comprises heat exchange means 8 arranged in the housing 2 for receiving heat from the beverage container 15 when the beverage container 15 is received housing 2 as part of a cooling arrangement 1. As a further part of the cooling arrangement 1 a condenser 11 is arranged in the air channel 7 and in thermal connection with the heat exchange means 8, so that the condenser 11 can emit heat received from the beverage container 15 to the air channel 7.

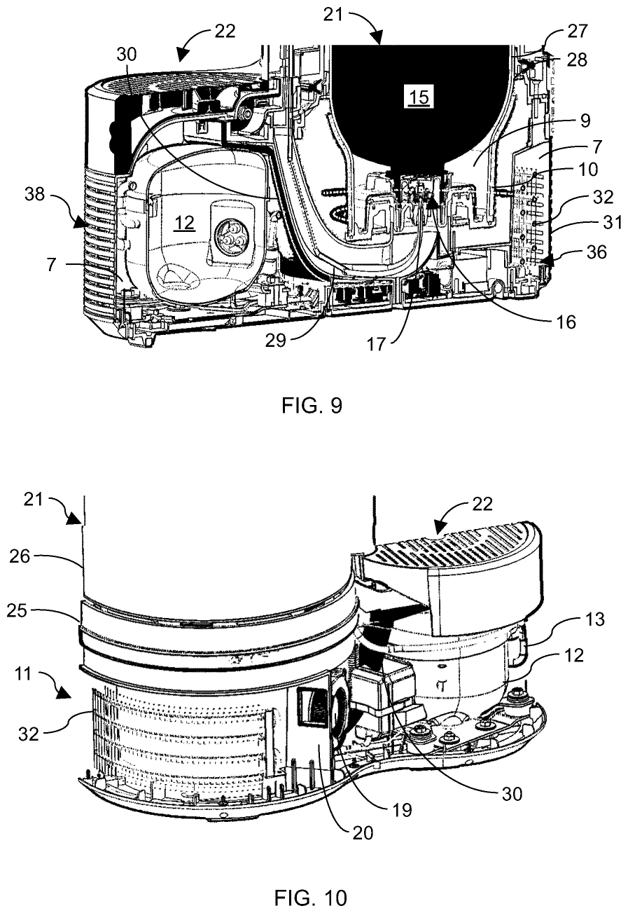

The heat exchange means 8 may be a heat sink wall 9 arranged in thermal connection with the beverage container 15 when the beverage container 15 is received in the housing 2, as shown in FIG. 2, and better illustrated in FIGS. 4 and 9. An evaporator 10 may also be arranged in thermal connection with the heat sink wall 9.

The cooling device 1 can further comprise, as part of the cooling arrangement 1, a compressor 12 which can provide a fix or adjustable pressure.

In the examples shown in FIGS. 1 and 2, the evaporator 10, the compressor 12, and the condenser 11 is interconnected through a cooling duct 13 for circulating a cooling substance; the duct further comprising an expansion valve 14 being arranged in the duct between the condenser 11 and the evaporator 10 to provide a vapor-compression cycle for cooling the beverage container 15. The cooling substance may be a refrigerant comprising at least one of hydrocarbon and hydrofluoroolefin, such as R-32, R-290, R-600a, R-454b, R-1234yf, R-514A, R-744 CO2, R-1234ze and R-1233zd, most preferably R-600a.

A pressure source 43 can be further arranged in the housing 2 for providing an elevated pressure from a gas supply and for applying this pressure on the beverage container 15 to dispense a beverage. The pressure source 43 is in fluid communication with an inner space of the housing 2 for pressurizing and applying a force onto the beverage container 15, collapsing the beverage container 15 and forcing the beverage through the beverage dispensing line 29 and out through the tapping head.

FIG. 2 shows a schematic horizontal cross-section along the axis S2 of the beverage dispensing system in accordance with an embodiment of the present disclosure. In this and other exemplary embodiments illustrated in the following figures, structures and features that are the same or similar to corresponding structures and features previously described or shown herein are denoted by the same reference numeral as previously used for simplicity.

As shown in FIG. 2, the housing 2 may comprise a first housing portion 21 for receiving the beverage container 15; and a second housing portion 22 arranged laterally to the first housing portion 21 and connected to the first housing portion 21 through the side wall 5. In the example illustrated in FIG. 2, the outlet apertures 61 are arranged in the side wall 5 of the first housing portion 21; and the inlet apertures 62 are arranged in the side wall 5 of the second housing portion 22, thereby allowing a channeled airflow between an outer side 52 of the first housing portion 21 and an outer side 52 of the second housing portion 22 through the air channel 7.

According to a specific example, both the heat exchange means 8 and the condenser 11 is arranged in the first housing portion 21; while the compressor 12 is arranged in the second housing portion 22.

As further shown in FIG. 2, at least one ventilator 19 is arranged in the air channel 7 for providing forced air flow in the air channel 7 at a fixed or adjustable speed. In preferred examples at least two ventilators 19 are arranged in the air channel 7, along opposite sides of the housing 2, the at least two ventilators 19 being arranged in parallel to provide a unilateral air flow, wherein air flows through all the ventilators 19 from the inlet aperture 62 to the outlet aperture 61.

The first housing portion 21 may be larger than the second housing portion 22, and the condenser 11 may be arranged in the first housing portion 21 so that it can provide a larger surface. The condenser 11 may be arranged at a side of the first housing portion 21 facing away from the second housing portion 22.

In an alternative embodiment (not shown) the second housing portion 22 is larger than the first housing portion 21, and the condenser 11 is arranged in the second housing portion 22, at a side of the second housing portion 22 facing away from the first housing portion 21.

FIG. 3 shows a detailed horizontal cross-section along the axis S2 of a beverage dispensing system with a cooling arrangement in accordance with an embodiment of the present disclosure. In this cross-section the arrangements of parts of the beverage dispensing system are more resembling specific working embodiments. In this and further preferred examples shown in FIGS. 2-4, the housing 2 is defined horizontally by a rounded hourglass shape, the side wall 5 comprising four curved segments 31 (explained in more detail at FIG. 6), the four curved segments 31 comprising two concave curved segments 34 and two convex curved segments 35 arranged intermittently. The condenser 11 and the compressor 12 in these embodiments are arranged at respective concave curved segments 34.

FIG. 4 shows an isometric view of a beverage dispensing system cut at a horizontal plane in accordance with an embodiment of the present disclosure. As shown in FIG. 4, and in more detail in FIG. 10, at least one partition wall 20 may further be arranged in the air channel 7 on an outflow side of the at least one ventilator 19. Each partition wall 20 can be arranged to fill the cross-section of the air channel 7, comprising a hole for restricting and channeling air flow from the respective ventilator 19 through the partition wall 20.

As illustrated below in FIG. 6, at least one partition wall 20 may further comprise flow directing means 23 for directing air flow from the partition wall 20 within the air channel 7, the flow directing means 23 being arranged on an opposite side of the at least one partition wall 20 to the ventilator 19. The flow directing means 23 may be in the form of a tapered spout of an adjustable or fixed direction, with a fixed or adjustable diameter.

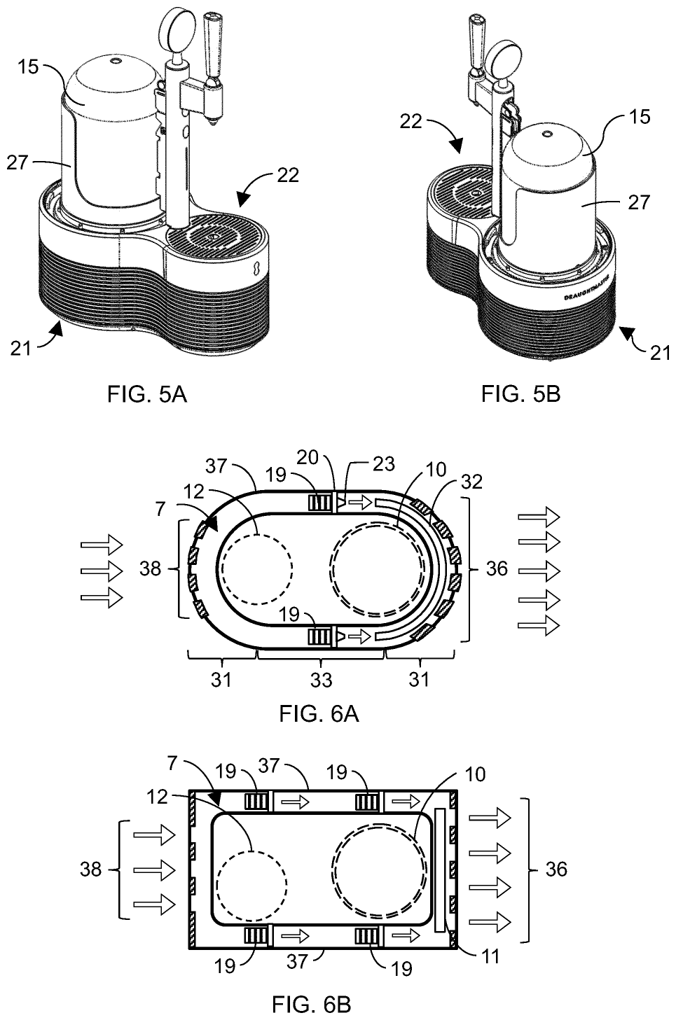

In some examples, as illustrated in FIGS. 5A and 5B, the cooling arrangement 1 may further comprise an additional heat sink layer 27, made from a material of high thermal conductivity such as aluminium, for providing additional cooling when the beverage container 15 is received in the receptacle 24. The heat sink layer 27 may be arranged in a base portion 25 or a lid portion 26 of the housing 2, depending on location of the connection between the base 25 and the lid 26, i.e. which portion has larger surface area.

As shown in FIGS. 6A and 6B the side wall 5 may comprise an inlet segment 38 comprising a set of inlet apertures including the inlet aperture 62; and an outlet segment 36 comprising a set of outlet apertures including the outlet aperture 61. In these exemplary embodiments at least one continuous segment 37 uninterrupted by apertures is also arranged between the inlet segment 38 and the outlet segment 36. However, it is also possible that the side wall is apertured all along. The condenser 11 can be arranged in the air channel 7 in front of the outlet segment 36 for enabling efficient heat emission through the side wall 5. In the embodiments illustrated, the condenser 11 is arranged in parallel to the outlet segment 36, with a clearance arranged between the condenser 11 and the outlet segment 36.

As shown in FIGS. 6A and 6B specifically, but also in more embodiments throughout FIGS. 1-5, 10, and 12A, the side wall 5 comprises at least one curved segment 31. As shown in these examples, at least one of the inlet apertures 62 or the outlet apertures 61 is arranged in such a curved segment 31; and at least a portion of the condenser 11 is arranged in the air channel 7 along a curved segment 31, the condenser 11 comprising curved ducts 32 corresponding to the shape respective curved segment 31.

In the embodiments as shown in e.g. FIG. 3, FIG. 6A, at least some of the curved segments 31 are shaped as a half cylinder. In examples shown in e.g. FIGS. 2-4, 5A, 5B, and 6A the side wall 5 comprises at least two curved segments 31 arranged at opposite sides of the housing 2, wherein the inlet aperture 62 and the outlet aperture 61 are arranged in different ones of the at least two curved segments 31; and wherein a compressor 12 is arranged in the housing 2 at a curved segment 31 opposite to the condenser 11.

The condenser 11 may be arranged along at least a portion of the curved segment 31. In other possible embodiments the condenser 11 is arranged along the entirety of the curved segment 31, or the condenser 11 may even be extending over the curved segment 31 on at least on one end, as shown in FIG. 6A.

In examples such as shown in FIG. 12A, the housing 2 has a cylindrical shape. The cylindrical shape may be defined by an oval, circular, or even elliptical cross section.

In an embodiment such as shown in FIG. 12A, the side wall 5 only comprises curved segments 31.

In other possible embodiments such as shown in FIGS. 6B and 12B, the side wall 5 does not comprise any curved segments.

In some embodiment such as shown in FIG. 6A, the side wall 5 only comprises two curved segments 31, the two curved segments 31 being connected by straight segments 33, providing a straight slot shape for the housing 2.

As illustrated in FIG. 7, which is a more detailed cross-section corresponding to the embodiment of FIG. 1, the housing 2 may comprise a receptacle 24 for receiving the beverage container 15, the receptacle 24 comprising a base portion 25 and an at least partially removable lid portion 26.

The receptacle 24 can define a sealable pressure chamber 44 when the lid portion 26 is attached to the base portion 25, and pressurized fluid from the pressure source 43 can be applied to the pressure chamber 44 for pressurizing the beverage container 15 to dispense a beverage.

As shown in the partial cross-section of FIG. 8, the beverage container 15 may comprise a closure 16 with a beverage outlet 17. In this exemplary embodiment, as shown in FIG. 7, the housing 2 comprises a cavity 18 designed to accommodate the closure 16 and at least a portion of the beverage container 15 when the beverage container 15 is received in the housing 2. The cavity 18 is delimited at least partially by the heat sink wall 9 with evaporator 10 lines arranged in a spiral to at least partially surround the heat sink wall 9 for cooling the beverage container 15.

As further shown in FIG. 8, the heat exchange means 8 comprising the evaporator 10 arranged in thermal connection with the heat sink wall 9 may be arranged in the base portion 25, and at least a portion of the additional heat sink layer 27 as described before can be arranged in the lid portion 26. In such embodiments, the housing 2 may further comprise a thermal bridge 28 of any known and suitable means, arranged between the base portion 25 and the lid portion 26, providing a thermally conductive connection between the additional heat sink layer 27 and any of the heat exchange means 8.

As further shown in FIG. 8, the beverage dispensing line 29 connected on one end to a beverage outlet 17, and the cooling arrangement 1 comprises a compressor 12 that can emit heat. For keeping the beverage being dispensed at a lower temperature, shielded from the heat emitted by the compressor 12, a heat insulation layer 30 may be arranged between at least a portion of the beverage dispensing line 29 and the compressor 12.

As also shown in FIGS. 7 and 8, at least one portion of the beverage dispensing line 29 may be disposed in thermal connection with the heat sink layer 27, when the beverage container 15 is received in the housing 2, for providing additional cooling for the beverage flowing in the beverage dispensing line 29. This can be achieved by for example arranging the portion of the beverage dispensing line 29 to run close to the beverage container 15 and using a metal-based thermal bridge between the heat sink layer 27 and the portion of the beverage dispensing line 29.

FIG. 9 shows a partial isometric cross-section along the axis S1 of a beverage dispensing system with a cooling arrangement 1 in accordance with an embodiment of the disclosure. As shown in the figure, a heat insulation layer 30 is arranged between a portion of the beverage dispensing line 29 and the compressor 12. The figure also illustrates the inlet segment 38 comprising a set of horizontal inlet apertures 62; and an outlet segment 36 comprising a set of horizontal outlet apertures 61. The condenser 11 as shown in the right side of the figure is arranged in the air channel 7 along a curved back side of the housing, the condenser 11 comprising curved ducts 32 corresponding to the shape a respective curved segment 31. As also can be seen in FIG. 9, the air channel 7 extends between the compressor 12 and the inlet segment 38.

FIG. 10 shows a partial isometric side view of a beverage dispensing system in accordance with an embodiment of the disclosure, wherein the housing and some further parts are removed for better visibility of parts of the cooling arrangement 1. In particular, a partition wall 20 is shown arranged in the air channel 7 on an outflow side of a ventilator 19. The partition wall 20 is be arranged to fill the cross-section of the air channel 7, comprising a hole for restricting and channeling air flow from the ventilator 19 through the partition wall 20. FIG. 10 furthers shows a practical arrangement of the cooling duct connecting the compressor 12 with the evaporator 10 (now shown). The figure also shows the arrangement of the base portion 25 and the removable lid portion 26 defining a sealable pressure chamber 44 as the lid portion 26 is attached to the base portion 25.

Finally, as also shown in FIG. 10, similarly as in FIG. 9, the condenser 11 comprises curved ducts 32 corresponding to the shape a respective curved segment 31 of the side wall 5 (not shown).

FIG. 11 show a schematic vertical cross-section of a beverage dispensing system in accordance with further possible embodiments of the present disclosure, wherein the tapping head is directly mounted on a body 5 of the beverage dispensing system. In such exemplary embodiments the beverage container 15 may comprise a beverage filled bag 40 inside an outer shell 41, wherein pressurized fluid from the pressure source 43 can be applied to a space 42 between the outer shell 41 and the bag 40 for pressurizing the beverage container 15 to dispense a beverage.

Apart from the above, this alternative embodiment comprises corresponding structures and features that are the same or similar to corresponding structures and features previously described and are shown herein denoted by the same reference numeral as previously used for simplicity, such as an evaporator 10, a condenser 11, and a compressor 12.

In particular, the housing 2 comprises evaporator 10 lines arranged in a spiral to surround the lower portion of the beverage container 15, which is arranged with a beverage outlet 17 connected to a beverage dispensing line 29 that leads to a tapping head.

Also similarly as described before, the housing 2 may comprise a receptacle 24 for receiving the beverage container 15, the receptacle 24 comprising a base portion 25 and an at least partially removable lid portion 26.

In all of the alternative embodiments shown in FIGS. 11, 12A and 12B, similarly as described before, at least one inlet aperture 62 is arranged in the side wall 5 of the housing 2 for allowing airflow from a space outside the housing 2 into the enclosure (illustrated by the arrows on the left); while a further at least one outlet aperture 61 is also arranged in the side wall 5 downstream from the inlet aperture 62 for allowing airflow from the enclosure to a space outside the housing 2 (illustrated by the arrows on the right).

An air channel 7 is arranged in the housing 2 of all embodiments to extend at least between the inlet aperture 62 and the outlet aperture 61. The air channel 7 in all cases extends along an inner side of the side wall 5. The side wall 5 may comprise an inlet segment 38 comprising a set of inlet apertures 62; and an outlet segment 36 comprising a set of outlet apertures 61. In these exemplary embodiments at least one continuous segment 37 uninterrupted by apertures is also arranged between the inlet segment 38 and the outlet segment 36, however it is also possible that the side wall is apertured all along. The condenser 11 as shown can be arranged in the air channel 7 in front of the outlet segment 36 for enabling efficient heat emission through the side wall 5. In the embodiments illustrated, the condenser 11 is arranged in parallel to the outlet segment 36, either in a straight (FIG. 12B) or curved shape (FIG. 12A) depending on the shape of the corresponding segment, with a clearance arranged between the condenser 11 and the outlet segment 36.

FIGS. 12A and 12B show schematic horizontal cross-sections of beverage dispensing systems in accordance with further alternative embodiments the of present disclosure, corresponding to the embodiment of FIG. 11 using a double-layered beverage container 15.

As described before, in embodiments such as shown in FIG. 12A, the housing 2 has a substantially cylindrical shape. The cylindrical shape may be defined by an oval, circular, or even elliptical cross section.

In the embodiments such as shown in FIG. 12A, the side wall 5 only comprises curved segments 31.

In other possible embodiments such as shown in FIG. 12B, the side wall 5 does not comprise any curved segments.

The beverage dispensing system may further comprise a first electric power unit including a mains supply and a second power unit including a battery supply, and, optionally, a third power supply including a solar power supply. In order to further enhance the modularity of the system, it may be compatible with different power supplies. For fixed indoor installations, a mains power supply, e.g. 115V or 230V AC household supply, is preferred since it offers essentially unlimited power to the system for powering both cooling and pressurization units as well as other features such as lighting etc. Batteries may advantageously be used in mobile appliances. The batteries may e.g. be rechargeable by the use of a mains supply and a power converter. Solar power may be used for directly powering the beverage dispensing system, however, due to the limited output of solar cells when no direct sunlight is available it is mostly considered an auxiliary power unit to be used in conjunction with rechargeable batteries.

The various aspects and implementations have been described in conjunction with various embodiments herein. However, other variations to the disclosed embodiments can understood and effected by those skilled in the art in practicing the claimed subject-matter, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems.

The reference signs used in the claims shall not be construed as limiting the scope. Unless otherwise indicated, the drawings are intended to be read (e.g., cross-hatching, arrangement of parts, proportion, degree, etc.) together with the specification, and are to be considered a portion of the entire written description of this disclosure. As used in the description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

1. A beverage dispensing system comprising
a housing comprising a bottom, a top, and a continuous side wall together defining an enclosure for receiving at least a portion of a collapsible beverage container;
a pressure source for applying pressure on the beverage container to at least partially collapse the beverage container to dispense a beverage;
an inlet aperture arranged in the side wall for allowing airflow from a space outside the housing into the enclosure;
an outlet aperture arranged in the side wall downstream from the inlet aperture for allowing airflow from the enclosure to a space outside the housing;
an air channel extending at least between the inlet aperture and the outlet aperture; and
a cooling arrangement comprising:
heat exchange means arranged in the housing for receiving heat from the beverage container when the beverage container is received housing; and
a condenser arranged in the air channel and in thermal connection with the heat exchange means, for emitting heat received from the beverage container to the air channel, wherein:
the side wall comprises at least one curved segment;
wherein at least one of said inlet aperture or said outlet aperture is arranged in a curved segment; and
wherein at least a portion of said condenser is arranged in the air channel along a curved segment, said condenser comprising curved ducts corresponding to the shape of a respective curved segment.

2. The beverage dispensing system according to claim 1, wherein the heat exchange means comprise a heat sink wall arranged in thermal connection with the beverage container when the beverage container is received in the housing, and an evaporator arranged in thermal connection with the heat sink wall;
wherein the cooling device further comprises a compressor;
the evaporator, the compressor, and the condenser being interconnected through a cooling duct for circulating a cooling substance; and
the duct further comprising an expansion valve being arranged in the duct between the condenser and the evaporator to provide a vapor-compression cycle for cooling the beverage container.

3. The beverage dispensing system according claim 2, wherein the beverage container comprises a closure with a beverage outlet,
wherein the housing comprises a cavity designed to accommodate the closure and at least a portion of the beverage container when the beverage container is received in the housing, and
wherein the cavity is delimited at least partially by the heat sink wall with the evaporator arranged at least partially surrounding the heat sink wall for cooling the beverage container.

4. The beverage dispensing system according to claim 1, wherein the housing comprises:
a first housing portion for receiving the beverage container;
a second housing portion arranged laterally to the first housing portion and connected to the first housing portion through the side wall; and wherein
the outlet aperture is arranged in the side wall of the first housing portion; and
the inlet aperture is arranged in the side wall of the second housing portion, thereby allowing a channeled airflow between an outer side of the first housing portion and an outer side of the second housing portion through the air channel.

5. The beverage dispensing system according to claim 4, wherein both the heat exchange means and the condenser is arranged in the first housing portion; and
wherein a compressor is arranged in the second housing portion.

6. The beverage dispensing system according to claim 1, wherein the side wall comprises:
an inlet segment comprising a set of inlet apertures including the inlet aperture;
an outlet segment comprising a set of outlet apertures including the outlet aperture; and
at least one continuous segment uninterrupted by apertures arranged between the inlet segment and the outlet segment.

7. The beverage dispensing system according to claim 6, wherein the condenser is arranged in the air channel in front of the outlet segment for enabling efficient heat emission through the side wall.

8. The beverage dispensing system according to claim 1, wherein at least one ventilator is arranged in the air channel for providing forced air flow in the air channel.

9. The beverage dispensing system according to claim 8, wherein at least two ventilators are arranged in the air channel, along opposite sides of the housing.

10. The beverage dispensing system according to claim 9, wherein the at least two ventilators are arranged in parallel to provide a unilateral air flow, wherein air flows through all the ventilators from the inlet aperture to the outlet aperture.

11. The beverage dispensing system according to claim 8, wherein at least one partition wall is arranged in the air channel on an outflow side of the at least one ventilator, each partition wall arranged to fill the cross-section of the air channel, and each partition wall comprising a hole for restricting and channeling air flow from the respective ventilator through the partition wall.

12. The beverage dispensing system according to claim 11, wherein at least one partition wall further comprises flow directing means for directing air flow from the partition wall within the air channel, the flow directing means being arranged on an opposite side of the at least one partition wall to the ventilator.

13. The beverage dispensing system according to claim 1, wherein the housing comprises a receptacle for receiving the beverage container, the receptacle comprising a base portion and an at least partially removable lid portion; and
wherein the receptacle further comprises an additional heat sink layer, arranged in at least one of the base portion or the lid portion, for providing additional cooling when the beverage container is received in the receptacle.

14. The beverage dispensing system according to claim 13, wherein at least a portion of the additional heat sink layer is arranged in the lid portion,
wherein the heat exchange means are arranged in the base portion; and
wherein the housing further comprises a thermal bridge arranged between the base portion and the lid portion, providing a thermally conductive connection between the additional heat sink layer and the heat exchange means.

15. The beverage dispensing system according to claim 13, wherein the receptacle defines a sealable pressure chamber when the lid portion is attached to the base portion, and wherein pressurized fluid from the pressure source can be applied to the pressure chamber for pressurizing the beverage container to dispense a beverage.

16. The beverage dispensing system according to claim 1, wherein the beverage container comprises a beverage filled bag inside an outer shell, wherein pressurized fluid from the pressure source can be applied to a space between the outer shell and the bag for pressurizing the beverage container to dispense a beverage.

17. The beverage dispensing system according to claim 1, wherein the beverage dispensing system comprises a beverage dispensing line connected on one end to a beverage outlet of the beverage container and arranged at least partially within the housing when the beverage container is received in the housing;
wherein the cooling device comprises a compressor; and
wherein the cooling device further comprises a heat insulation layer arranged between at least a portion of the beverage dispensing line and the compressor.

18. The beverage dispensing system according to claim 17, wherein a heat sink layer is arranged in the housing for providing additional cooling for the beverage container; and wherein at least one portion of the beverage dispensing line is disposed in thermal connection with the heat sink layer when the beverage container is received in the housing for providing additional cooling for a beverage flowing in the beverage dispensing line.

19. (canceled)

20. The beverage dispensing system according to claim 19, wherein the side wall comprises at least two curved segments arranged at opposite sides of the housing, wherein the inlet aperture and the outlet aperture are arranged in different ones of the at least two curved segments; and wherein a compressor is arranged in the housing at a curved segment opposite to the condenser.

21. The beverage dispensing system according to claim 20, wherein the housing is defined horizontally by a rounded hourglass shape, the side wall comprising four curved segments, the four curved segments comprising two concave curved segments and two convex curved segments arranged intermittently; and wherein the condenser and the compressor are arranged at respective concave curved segments.
